(19) United States
(12) Patent Application Publication
(10) Pub. No.: US 2010/0010943 A1
(43) Pub. Date: Jan. 14, 2010

(54) LEARNING DEVICE, LEARNING METHOD, AND PROGRAM

(76) Inventors: Masato ITO, Tokyo (JP); Kazumi Aoyama, Saitama (JP); Kuniaki Noda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/494,593

(22) Filed: Jun. 30, 2009

(30) Foreign Application Priority Data
Jul. 9, 2008 (JP) P2008-178806

(51) Int. Cl. G06F 15/18

(52) U.S. Cl. 706/12; 706/25; 706/54

(57) ABSTRACT

A learning device includes: a plurality of learning modules, each of which performs update learning to update a plurality of model parameters of a pattern learning model that learns a pattern using input data; model parameter sharing means for causing two or more learning modules from among the plurality of learning modules to share the model parameters; module creating means for creating a new learning module corresponding to new learning data for learning the pattern when the new learning data are supplied as the input data; similarity evaluation means for evaluating similarities among the learning modules after the update learning is performed over all the learning modules including the new learning module; and module integrating means for determining whether to integrate the learning modules on the basis of the similarities among the learning modules and integrating the learning modules.

### BACKGROUND OF THE INVENTION

1. Field of the Invention

The invention relates to a learning device, a learning method and a program and, more particularly, to a learning device, a learning method and a program that are able to obtain a pattern learning model having scalability and generalization capability.

2. Description of the Related Art

A pattern learning model that learns a pattern may be, for example, RNN (Recurrent Neural Network), RNNPB (Recurrent Neural Net with Parametric Bias), or the like. The scheme of learning of those pattern learning models is classified into a “local representation” scheme and a “distributed representation” scheme.

In the “local representation” scheme, a plurality of patterns are learned in each of a plurality of learning modules, each of which learns a pattern learning model (updates model parameters of a pattern learning model). Thus, one learning module stores one pattern.

In addition, in the “distributed representation” scheme, a plurality of patterns are learned in one learning module. Thus, one learning module stores a plurality of patterns at a time.

In the “local representation” scheme, one learning module stores one pattern, that is, one pattern learning model learns one pattern. Thus, there is a small interference in memory of a pattern between a learning module and another learning module, and memory of a pattern is highly stable. Then, the “local representation” scheme is excellent in scalability that it is possible to easily learn a new pattern by adding a learning module.

However, in the “local representation” scheme, one pattern learning model learns one pattern, that is, memory of a pattern is independently performed in each of a plurality of learning modules. Therefore, it is difficult to obtain generalization capability by structuring (commonizing) the relationship between respective memories of patterns of the plurality of learning modules, that is, it is difficult to, for example, generate, so to speak, an intermediate pattern, which differs from a pattern stored in a learning module and also differs from a pattern stored in another learning module.

On the other hand, in the “distributed representation” scheme, one learning module stores a plurality of patterns, that is, one pattern learning model learns a plurality of patterns. Thus, it is possible to obtain generalization capability by commonizing memories of a plurality of patterns owing to interference between the memories of the plurality of patterns in one learning module.

However, in the “distributed representation” scheme, stability of memories of patterns is low, so there is no scalability.

Here, Japanese Unexamined Patent Application Publication No. 2002-024795 describes that contexts of two RNNs are changed on the basis of an error between the contexts of two RNNs, one of which learns a pattern and the other one of which learns another pattern that correlates with the pattern to perform learning of the RNNs, and one of the contexts of the learned two RNNs is used as a context of the other RNN, that is, a context of one of the RNNs is caused to influence a context of the other one of the RNNs to generate output data (input data are input to an input layer of an RNN, and output data corresponding to the input data are output from an output layer of the RNN).

In addition, Yuuya Sugita, Jun Tani, “Learning Semantic Combinatoriality from the Interaction between Linguistic and Behavioral Processes”, Adaptive Behavior, Vol. 13, No. 1, 33-52 (2005), describes that RNNPBs learn by changing PBs of the two RNNPBs on the basis of a difference between the PBs of the two RNNPBs, one of which learns a pattern of language and the other learns a pattern of action, and one of the PBs of the learned two RNNPBs is caused to influence the other PB to generate output data.

### SUMMARY OF THE INVENTION

As described above, in learning of an existing pattern learning model, it is possible to obtain a pattern learning model having scalability or a pattern learning model having generalization capability; however, it is difficult to obtain a pattern learning model having both scalability and generalization capability at a time.

It is desirable to be able to obtain a pattern learning model having both scalability and generalization capability at a time.

According to an embodiment of the invention, a learning device includes: a plurality of learning modules, each of which performs update learning to update a plurality of model parameters of a pattern learning model that learns a pattern using input data; model parameter sharing means for causing two or more learning modules from among the plurality of learning modules to share the model parameters; module creating means for creating a new learning module corresponding to new learning data for learning the pattern when the new learning data are supplied as the input data; similarity evaluation means for evaluating similarities among the learning modules after the update learning is performed over all the learning modules including the new learning module; and module integrating means for determining whether to integrate the learning modules on the basis of the similarities among the learning modules and integrating the learning modules.

According to another embodiment of the invention, a learning method includes the steps of: performing update learning to update a plurality of model parameters of a pattern learning model that learns a pattern using input data in each of a plurality of learning modules; causing two or more learning modules from among the plurality of learning modules to share the model parameters; creating a new learning module corresponding to new learning data for learning the pattern when the new learning data are supplied as the input data; evaluating similarities among the learning modules after the update learning is performed over all the learning modules including the new learning module; and determining whether to integrate the learning modules on the basis of the similarities among the learning modules and integrating the learning modules.

According to further another embodiment of the invention, a program for causing a computer to function as: a plurality of learning modules, each of which performs update learning to update a plurality of model parameters of a pattern learning model that learns a pattern using input data; model parameter sharing means for causing two or more learning modules from among the plurality of learning modules to share the model parameters; module creating means for creating a new learning module corresponding to new learning data for learning the pattern when the new learning data are supplied as the input data; similarity evaluation means for evaluating similarities among the learning modules after the update learning is performed over all the learning modules including the new learning module; and module integrating means for determining whether to integrate the learning modules on the basis of the similarities among the learning modules and integrating the learning modules.

In the embodiment of the invention, update learning is performed to update a plurality of model parameters of a pattern learning model that learns a pattern using input data in each of a plurality of learning modules, and the model parameters are shared between two or more learning modules from among the plurality of learning modules. In addition, when new learning data for learning the pattern are supplied as the input data, a new learning module corresponding to the new learning data is created, and the update learning is performed over all the learning modules including the new learning module. After that, similarities among the learning modules are evaluated, and it is determined whether to integrate the learning modules on the basis of the similarities among the learning modules, and then the learning modules are integrated.

### BRIEF DESCRIPTION OF THE DRAWINGS

FIG. 1 is a block diagram that shows a configuration example of one embodiment of a learning device, which is a basic learning device to which an embodiment of the invention is applied;

FIG. 2 is a flowchart that illustrates a learning process of the learning device shown in FIG. 1;

FIG. 3 is a block diagram that snows a configuration example of the learning device shown in FIG. 1 when RNNPBs are employed as pattern learning models;

FIG. 4 is a flowchart that illustrates a learning process of the learning device shown in FIG. 1 when RNNPBs are employed as pattern learning models;

FIG. 5 is a view that shows the results of simulation;

FIG. 6 is a view that shows the results of simulation;

FIG. 7 is a view that shows the results of simulation;

FIG. 8 is a view that shows the results of simulation;

FIG. 9A to FIG. 9E are views that show time-series data used in simulation;

FIG. 10 is a view that schematically shows that model parameters of each RNNPB are shared;

FIG. 11 is a view that schematically shows the relationship among a “local representation” scheme, a “distributed representation” scheme and an “intermediate representation” scheme;

FIG. 12 is a block diagram that stows a configuration example of one embodiment of a learning device to which an embodiment of the invention is applied;

FIG. 13 is a flowchart that illustrates an additional learning process of the learning device shown in FIG. 12;

FIG. 14 is a flowchart that illustrates an integrating process of FIG. 13;

FIG. 15 is a flowchart that illustrates the integrating process of FIG. 13 when RNNs are employed as pattern learning models;

FIG. 16 is a view that conceptually shows a process of adding a new learning module;

FIG. 17 is a view that conceptually shows a process of integrating learning modules; and

FIG. 18 is a block diagram that shows a configuration example of a computer according to an embodiment of the invention.

### DESCRIPTION OF THE PREFERRED EMBODIMENTS

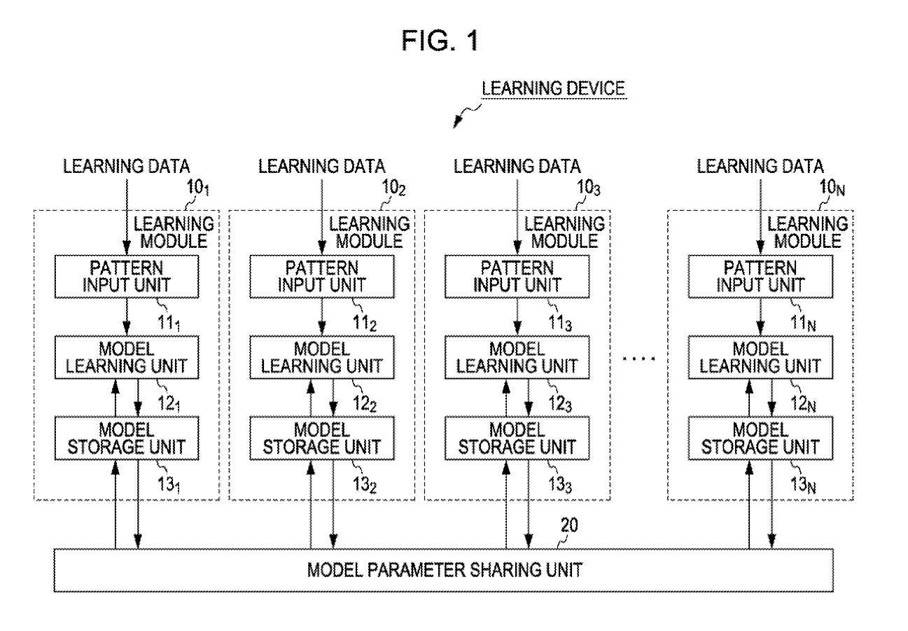

FIG. 1 is a configuration example of one embodiment of a learning device, which is a base of a learning device to which an embodiment of the invention is applied.

As shown in FIG. 1, the learning device is formed of a plurality of N learning modules 10₁ to 10₅ and a model parameter sharing unit 20.

Each learning module 10₁ (i=1, 2, . . . , N) is formed of a pattern input unit 11₁, a model learning unit 12₁ and a model storage unit 13₁, and uses input data to perform update learning to update a plurality of model parameters (learning resources) of a pattern learning model.

That is, each pattern input unit 11₁ is supplied with input data of a pattern (category) that a pattern learning model stored in the model storage unit 13₁ acquires (learns) as learning data used for learning of the pattern learning model.

The pattern input unit 11₁ converts the learning data supplied thereto into data in an appropriate format for learning of the pattern learning model, and then supplies the data to the model learning unit 12₁. That is, for example, when learning data are time-series data, the pattern input unit 11₁, for example, separates the time-series data in a fixed length and then supplies the separated time-series data to the model learning unit 12₁.

The model learning unit 12₁ uses the learning data supplied from the pattern input unit 11₁ to perform update learning to update a plurality of model parameters of the pattern learning model stored in the model storage unit 13₁.

The model storage unit 13₁ has a plurality of model parameters and stores a pattern learning model that learns a pattern. That is, the model storage on it 13₁ stores a plurality of model parameters of a pattern learning model.

Here, the pattern learning model may, for example, employ a model, or the like, that learns (acquires) (stores) a time-series pattern, which is a pattern in time series, or a dynamics that represents a dynamical system changing over time.

A model that learns a time-series pattern is, for example, an HMM (Hidden Markov Model), or the like, and a model that learns a dynamics is a neural network, such as an RNN, an FNN (Feed Forward Neural Network) and an RNNPB, or an SVR (Support Vector Regression), or the like.

For example, for an HMM, a state transition probability that indicates a probability at which a state makes a transition in the HMM and an output probability that indicates a probability at which an observed value is output from the HMM or an output probability density function that indicates a probability density when a state makes a transition are model parameters of the HMM.

In addition, for example, for a neural network, a weight assigned to an input to a unit (node), corresponding to a neuron, from another unit is a model parameter of the neural network.

Note that there are more than one state transition probability, output probability or output probability density function of an HMM and more than one weight of a neural network.

The model parameter sharing unit 20 performs sharing process to cause two or more learning modules from among the N learning modules 10₁ to 10₅ to share model parameters. As the model parameter sharing unit 20 performs sharing process, two or more learning modules from among the N learning modules 10₁ to 10₅ share model parameters.

Note that, hereinafter, for easy description, the model parameter sharing unit 20 performs sharing process to cause all the N learning modules 10₁ to 10_{N} to share model parameters.

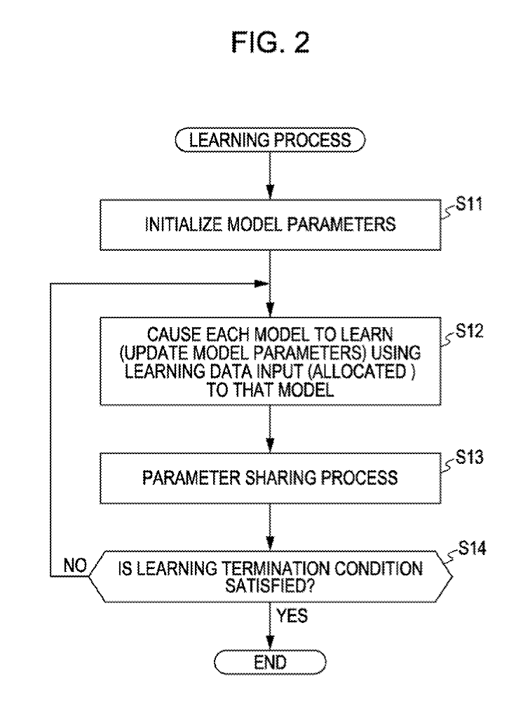

Next, the learning process in which the learning device shown in FIG. 1 learns a pattern learning model will be described with reference to the flowchart shown in FIG. 2.

In step S11, the model learning unit 12₁ of each learning module 10₁ initializes model parameters stored in the model storage unit 13₁, for example, by random number, or the like, and then the process proceeds to step S12.

In step S12, the learning module 10₁ waits until learning data to be learned by the learning module 10₁ are supplied (input), and then uses the learning data to perform update learning to update the model parameters.

That is, in step S12, in the learning module 10₁, the pattern input unit 11₁, where necessary, processes the learning data supplied to the learning module 10₁ and then supplies the learning data to the model learning unit 12₁.

Furthermore, in step 312, the model learning unit 12₁ uses the learning data supplied from the pattern input unit 11₁ to perform update learning to update a plurality of model parameters of the pattern learning model stored in the model storage unit 13₁, and then updates (overwrites) the content stored in the model storage unit 13₁ by a plurality of new model parameters obtained through the update learning.

Here, the processes in steps S₁₁ and S₁₂ are performed in all the N learning modules 10₁ to 10_{N}.

After step 812, the process proceeds to step S13, and then the model parameter sharing unit 20 performs sharing process to cause all the N learning modules 10₁ to 10_{N} to share the model parameters.

That is, when focusing on, for example, the mth model parameter from among a plurality of model parameters of the learning module 10₁, the model parameter sharing unit 20 corrects the mth model parameter of the learning module 10₁ on the basis of the respective mth model parameters of the N learning modules 10₁ to 10₅.

Furthermore, the model parameter sharing unit 20 corrects the mth model parameter of the learning module 102 on the basis of the respective mth model parameters of the N learning modules 10₁ to 10_{N}, and, thereafter, similarly. corrects the respective mth model parameters of the learning modules 10₃ to 10_{N}.

As described above, the model parameter sharing unit 20 corrects the mth model parameter of the learning module 10₁ on the basis of the respective mth model parameters of the N learning modules 10₁ to 10_{N}. Thus, each of the respective mth model parameters of the N learning modules 10₁ to 10_{N} is influenced by all the respective mth model parameters of the N learning modules 10₁ to 10_{N} (all the mth model parameters of the N learning modules 10₁ to 10_{N} influence each of the mth model parameters of the N learning modules 10₁ to 10₅).

In this way, all the model parameters of the plurality of learning modules influence each of the model parameters of the plurality of learning modules (each of the model parameters of the plurality of learning modules is influenced by all the model parameters of the plurality of learning modules). This is to share model parameters among the plurality of learning modules.

In step S₁₃, the model parameter sharing unit 20 performs sharing process over all the plurality of model parameters stored in the model storage unit 13₁ of the learning module 10₁, and then updates the content stored in the model storage units 13₁ to 13_{N} using the model parameters obtained through the sharing process.

After step S13, the process proceeds to step S14, and then the learning device shown in FIG. 1 determines whether the learning termination condition is satisfied.

Here, the learning termination condition in step S14 may be, for example, when the number of learning times, that is, the number of times steps S12 and S13 are repeated, reaches a predetermined number of times, when the update learning in step S12 is performed using all pieces of prepared learning data, or when, if a true value of output data to be output for input data has been obtained, an error of output data output from the pattern learning model for the input data with respect to the true value is smaller than or equal to a predetermined value.

In step S14, when it is determined that the learning termination condition is not satisfied, the process returns to step S12, and, thereafter, the same processes are repeated.

In addition, in step S14, when it is determined that, the learning termination condition is satisfied, the process ends.

Note that the processes of step S12 and step S13 may be performed in reverse order. That is, it is applicable that, after the sharing process is performed to cause all the N learning modules 10₁ to 10_{N} to share the model parameters, update learning is performed to update the model parameters.

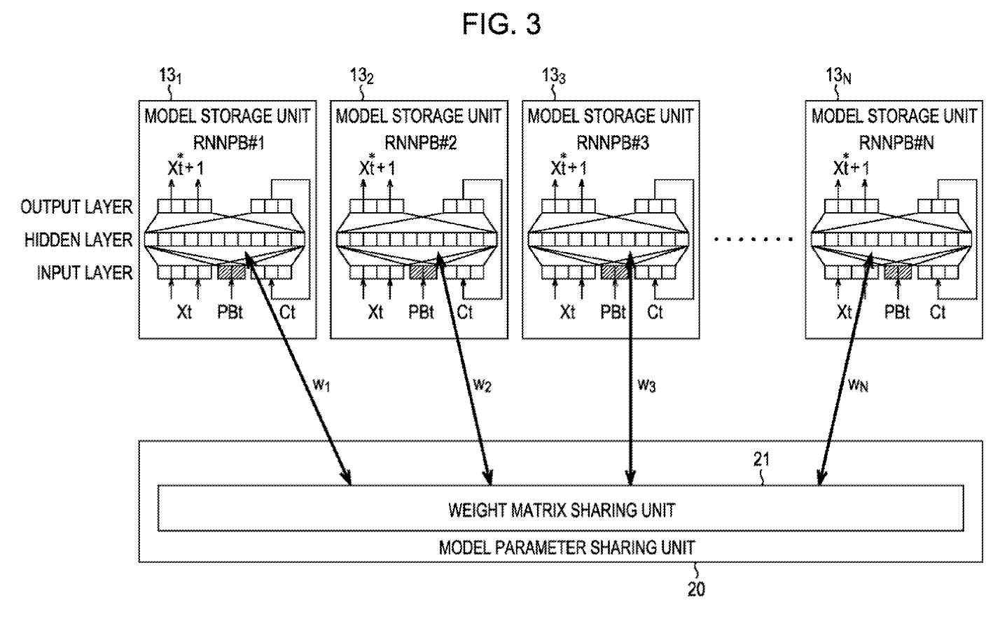

Next, FIG. 3 shows a configuration example of the learning device shown in FIG. 1 when RNNPBs are employed, as pattern learning models.

Note that in FIG. 3, the pattern input unit 11₁ and model learning unit 12₁ of each learning module 10₁ are not shown.

Each model storage unit 135ᵢ stores an RNNPB (model parameters that define an RNNPB). Hereinafter, the RNNPB stored in the model storage unit 13₁ is referred to as RNNPB #i where appropriate.

Bach RNNPB is formed of an input layer, a hidden layer (intermediate layer) and an output layer. The input layer, hidden layer and output layer are respectively formed of selected number of units corresponding to neurons.

In each RNNPB, input data xₜ, such as time-series data, are input (supplied) to input units, which are a portion of units of the input layer. Here, the input data xₜ may be, for example, the characteristic amount of an image or audio, the locus of movement of a portion corresponding to a hand or foot of a robot, or the like.

In addition, a PB (Parametric Bias) is input to PB units, which are a portion of units of the input layer other than the input units to which the input data xₜ are input. With the PB, even when the same input data xₜ are input to RNNPBs in the same state, different output data x*ₜ₊₁ may be obtained by changing the PB.

Output data output from a portion of units of the output layer are fed back to context units, which are the remaining units of the input layer other than the input units to which the input data xₜ are input as a context that indicates the internal state.

Here, the PB and context at time t, which are input to the PB units and context units of the input layer when input data xₜ at time t are input to the input units of the input layer are respectively denoted by PBₜ and cₜ.

The units of the hidden layer operate weighted addition using a predetermined weight for the input data xₜ, PBₜ and context cₜ input to the input layer, calculate a nonlinear function that uses the results of the weighted addition as arguments, and then outputs the calculated results to the units of the output layer.

As described above, output data of a context cₜ₊₁ at the next time t+1 are output from a portion of units of the output layer, and are fed back to the input layer. In addition, a predicted value x*ₜ₊₁ or the input data xₜ₊₁ at the next time t+1 of the input data xₜ is, for example, output from the remaining units of the output layer as output data corresponding to the input data xₜ.

Here, in each RNNPB, an input to each unit is subjected to weighted addition, and the weight used for the weighted addition is a model parameter of the RNNPB. Five types of weights are used as model parameters of the RNNPB. The weights include a weight from input units to units of the hidden layer, a weight from PB units to units of the hidden layer, a weight from context units to units of the hidden layer, a weight from units of the hidden layer to units of the output layer and a weight from units of the hidden layer to context units.

When the above RNNPB is employed as a pattern learning model, the model parameter sharing unit 20 includes a weight matrix sharing unit 21 that causes the learning modules 10₁ to 10_{N} to share weights, which serve as the model parameters of each RNNPB.

Here, the plurality of weights are present as the model parameters of each RNNPB, and a matrix that includes the plurality of weights as components is called a weight matrix.

The weight matrix sharing unit 21 causes the learning modules 10₁ to 10₅ to share all the weight matrices, which are the plurality of model parameters of the RNNPB #1 to RNNPB #N and stored respectively in the model storage units 13₁ to 13_{N}.

That is, if the weight matrix of the RNNPB #i is denoted by wᵢ, the weight matrix sharing unit 21 corrects the weight matrix wᵢ on the basis of all the weight matrices w₁ to w_{N} of the respective N learning modules 10₁ to 10_{N} to thereby perform sharing process to make all the weight matrices w₁ to w₅ influence the weight matrix wᵢ.

Specifically, the weight matrix sharing unit 21, for example, corrects the weight matrix wᵢ of the RNNPB #i in accordance with the following equation (1).

wᵢ=wᵢ+Δwᵢ (1)

Here, in equation (1), Δwᵢ is a correction component used to correct the weight matrix wᵢ, and is, for example, obtained in accordance with equation (2).

$$Δ {w}_{i} = {α}_{i} {\sum }_{j = 1}^{N} {β}_{ij} ( {w}_{j} - {w}_{i} ) \qquad ( 2 )$$

In equation (2), βᵢⱼ denotes a coefficient that indicates a degree to which each weight matrix wⱼ of the RNNPB #1 (j=1, 2, . . . , N) influences the weight matrix wᵢ of the RNNPB #i.

Thus, the summation Σβᵢⱼ(wⱼ−wᵢ) on the right-hand side in equation (2) indicates a weighted average value of errors (differentials) of the respective weight matrices w₁ to w_{N} of the RNNPB #1 to RNNPB #N with respect to the weight matrix wᵢ using the coefficient βᵢⱼ as a weight, and αᵢ is a coefficient that indicates a degree to which the weighted average value Σβᵢⱼ(wⱼ−wᵢ) influences the weight matrix wᵢ.

The coefficients αᵢ and βᵢ₅ may be, for example, larger than 0.0 and smaller than 1.0.

According to equation (2), as the coefficient αᵢ reduces, sharing becomes weaker (the influence of the weighted average value Σβᵢ₅(wⱼ−wᵢ) received by the weight matrix w₁ reduces), whereas, as the coefficient αᵢ increases, sharing becomes stronger.

Note that a method of correcting the weight matrix w₁ is not limited to equation (1), and may be, for example, performed in accordance with equation (3).

$${w}_{i} = {α}_{i}^{′} \cdot {w}_{i} + ( 1 - {α}_{i}^{′ } ) \cdot {\sum }_{j = 1}^{N} {β}_{ij}^{′} \cdot {w}_{j} \qquad ( 3 )$$

Here, in equation (3), βᵢⱼ denotes a coefficient that indicates a degree to which each weight matrix wⱼ of the RNNPB #j (j=1, 2, . . . , N) influences the weight matrix wᵢ of the RNNPB #i.

Thus, the summation Σβᵢⱼ′wⱼ at the second, term of the right-hand side in equation (3) indicates a weighted average value of the weight matrices w₁ to w_{N} of the RNNPB ∩1 to the RNNPB #N using the coefficient βᵢ₅′ as a weight, and αᵢ′ is a

coefficient that indicates a degree to which the weighted average value Σβᵢ₅ ′wⱼ influences the weight matrix wᵢ.

The coefficients αᵢ′ and βᵢⱼ′ may be, for example, larger than 0.0 and smaller than 1.0.

According to equation (3), as the coefficient αᵢ′ increases, sharing becomes weaker (the influence of the weighted average value Σβᵢⱼ′wⱼ received by the weight matrix wᵢ reduces), whereas, as the coefficient αᵢ′ reduces, sharing becomes stronger.

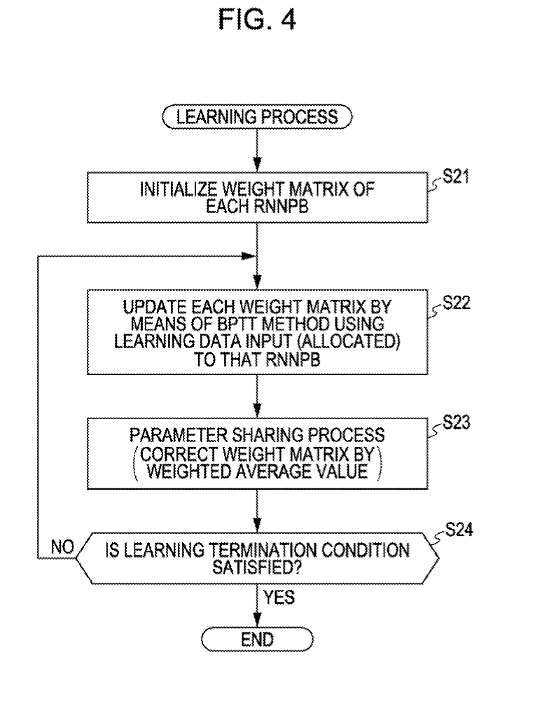

Next, the learning process or the learning device shown in FIG. 1 when RNNPBs are employed as pattern learning models will be described with reference to the flowchart of FIG. 4.

In step S21, the model learning unit 12ᵢ of each learning module 10₁ initializes the weight matrix wᵢ, which has model parameters of the RNNPB #i stored in the model storage unit 13ᵢ, for example, by random number, or the like, and then the process proceeds to step 322.

In step S22, the learning module 10ᵢ waits until learning data xₜ to be learned by the learning module 10ᵢ are input, and then uses the learning data xₜ to perform update learning to update the model parameters.

That is, in step S22, in the learning module 10ᵢ, the pattern input unit 11ᵢ, where necessary, processes the learning data xₜ supplied to the learning module 10ᵢ, and then supplies the learning data xₜ to the model learning unit 12ᵢ.

Furthermore, in step S22, the model learning unit 12ᵢ uses the learning data xₜ supplied from the pattern input unit 11ᵢ to perform update learning to update the weight matrix wᵢ of the RNNPB #i stored in the model storage unit 13ᵢ by means of, for example, BPTT (Back-Propagation Through Time) method, and then updates the content stored in the model storage unit 13ᵢ by the weight matrix wᵢ, which has new model parameters obtained, through the update learning.

Here, the processes in steps S21 and S22 are performed in all the N learning modules 10₁ to 10_{N}.

In addition, the BPTT method is, for example, described in Japanese Unexamined Patent Application Publication No. 2002-236904, or the like.

After step S22, the process proceeds to step S23, and then the weight matrix sharing unit 21 of the model parameter sharing unit 20 performs sharing process to cause all the N learning modules 10₁ to 10_{N} to share all the weight matrices w₁ to w₅.

That is, in step S23, the weight matrix sharing unit 21, for example, uses the weight matrices w₁ to w_{N} stored respectively in the model storage units 13₁ to 13_{N} to calculate correction components Δw₁ to Δw_{N} in accordance with equation (2), and then corrects the weight matrices w₁ to w_{N} stored respectively in the model storage units 13₁ to 13_{N} using the correction components Δw₁ to Δw₅ in accordance with equation (1).

After step S23, the process proceeds to step S24, and then the learning device shown in FIG. 1 determines whether the learning termination condition is satisfied.

Here, the learning termination condition that in step S24 may be, for example, when the number of learning times, that is, the number of times steps S22 and S23 are repeated, reaches a predetermined number of times, or when an error of output data x*ₜ₊₁ output from the RNNPB #i for input data xₜ, that is, a predicted value x*ₜ₊₁ of the input data xₜ₊₁, with respect to the input data xₜ₊₁ is smaller than or equal to a predetermined value.

In step S24, when it is determined that the learning termination condition is not satisfied, the process returns to step S22, and, thereafter, the same processes are repeated, that is, the update learning of the weight matrix wᵢ and the sharing process are alternately repeated.

In addition, in step S24, when it is determined that the learning termination condition is satisfied, the process ends.

Note that, in FIG. 4 as well, the processes of step S22 and step S23 may be performed in reverse order.

As described above, in each of the plurality of learning modules 10₁ to 10_{N} that are excellent in scalability, model parameters are shared while update learning is performed to update the model parameters of each of the plurality of learning modules 10₁ to 10_{N}. Thus, generalization capability obtained through learning in only one learning module may be obtained by all the plurality of learning modules 10₁ to 10_{N}. As a result, it is possible to obtain a pattern learning model that has scalability and generalization capability at a time.

That is, a large number of patterns may be acquired (stored), and a commonality of a plurality of patterns may be acquired. Furthermore, by acquiring a commonality of a plurality of patterns, it is possible to recognize or generate an unlearned pattern on the basis of the commonality.

Specifically, for example, when audio data of N types of phonemes are given to each of the N learning modules 10₁ to 10_{N} as learning data, and learning of the pattern learning models is performed, the pattern learning models are able to recognize or generate audio data of a time-series pattern that is not used for learning. Furthermore, for example, when N types of driving data for driving an arm of a robot are given to each of the N learning modules 10₁ to 10_{N} as learning data, and learning of the pattern learning models is performed, the pattern learning models are able to generate time-series pattern driving data that are not used for learning and, as a result, the robot is able to perform untaught, action of the arm.

In addition, the learned pattern learning models are able to evaluate similarity among the pattern learning models on the basis of distances among model parameters (resources) of the pattern learning models, and to cluster patterns as a cluster, each of which includes pattern learning models having high similarity.

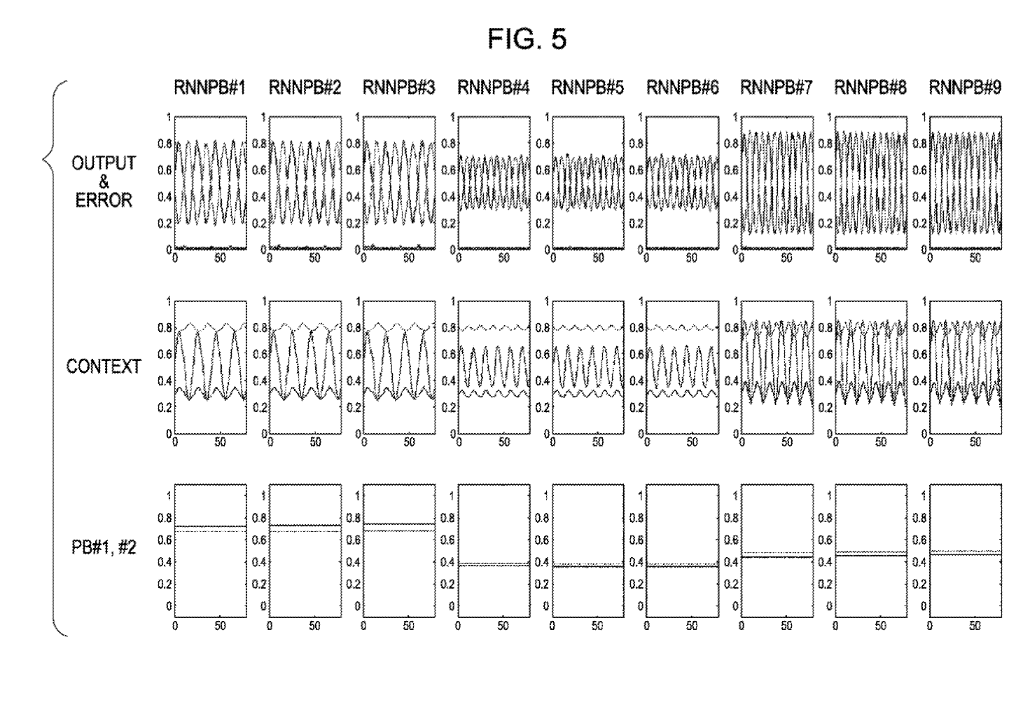

Next, the results of simulation of learning process (hereinafter, referred to as share learning process where appropriate) performed by the learning device shown in FIG. 1, conducted by the inventors, will be described with reference to FIG. 5 to FIG. 9E.

FIG. 5 shows pieces of data about pattern learning models on which learning is performed in share learning process.

Note that, in the simulation, nine RNNPB #1 to RNNPB #9, to which two PBs are input to the input layers and three contexts are fed back to the input layers, were employed as pattern learning models, and nine pieces of time-series data that are obtained by superimposing three different noises N #1, N #2 and N #3 on time-series data of three patterns P #1, P #2 and P #3 as learning data were used.

In addition, time-series data obtained by superimposing the noise N #1 on time-series data of the pattern R #1 are given to the RNNPB #1 as learning data, time-series data obtained by superimposing the noise N #2 on time-series data of the pattern P #1 are given to the RNNPB #2 as learning data, and time-series data obtained by superimposing the noise N #3 on time-series data of the pattern P #1 are given to the RNNPB #3 as learning data.

Similarly, time-series data obtained by superimposing the noise N #1 on time-series data of the pattern P #2 are given to the RNNPB #4 as learning data, time-series data obtained by superimposing the noise N #2 on time-series data of the pattern P #2 are given to the RNNPB #5 as learning data, and time-series data obtained by superimposing the noise N #3 on time-series data of the pattern P #2 are given to the RNNPB #6 as learning data. In addition, time-series data obtained by superimposing the noise N #1 on time-series data of the pattern P #3 are given to the RNNPB #7 as learning data, time-series data obtained by superimposing the noise N #2 on time-series data of the pattern P #3 are given to the RNNPB #8 as learning data, and time-series data obtained by superimposing the noise N #3 on time-series data of the pattern P #3 are given to the RNNPB #9 as learning data.

Mote that update learning was performed so as to reduce an error (prediction error) of a predicted value x*ₜ₊₁ of input data xₜ₊₁, which are output data output from each RNNPB for the input data xₜ, with respect to the input data xₜ₊₁.

The uppermost row in FIG. 5 shows output data output respectively from the RNNPB #1 to RNNPB #9 and prediction errors of the output data when learning data given at the time of learning are given to the learned RNNPB #1 to RNNPB #9 as input data.

In the uppermost row in FIG. 5, the prediction errors are almost zero, so the RNNPB #1 to the RNNPB #9 output the input data, that is, output data that substantially coincide with the learning data given an the time of learning.

The second row from above in FIG. 5 shows changes over time of three contexts when the learned RNNPB #1 to RNNPB #9 output the output data shown in the uppermost row in FIG. 5.

In addition, the third row from above in FIG. 5 show changes over time of two PB2 (hereinafter, two PB2 are respectively referred to as PB #1 and PB #2 where appropriate) when the learned RNNPB #1 to RNNPB #9 output the output data shown in the uppermost row in FIG. 5,

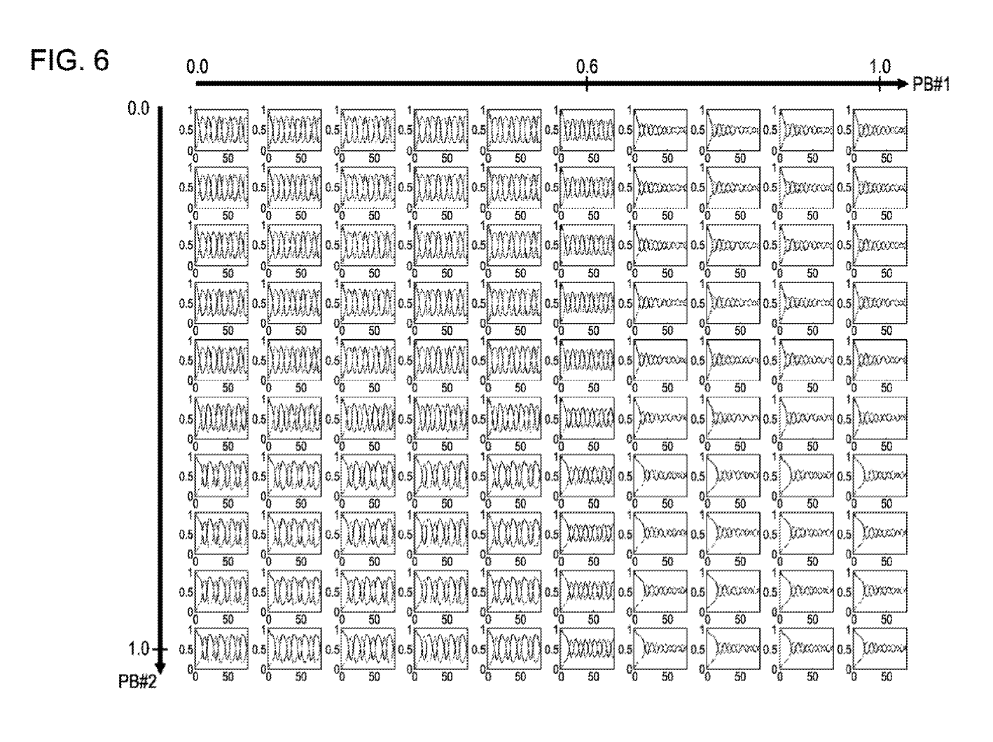

FIG. 6 shows output data output to the PB #1 and PB #2 of each value from, for example, the fifth RNNPB #5 from among the learned RNNPB #1 to RNNPB #9.

Note that in FIG. 6, the abscissa axis represents the PB #1, and the ordinate axis represents the PB #2.

According to FIG. 6, the RNNPB #5 outputs output data that substantially coincide with learning data given at the time of learning when the PB #1 is about 0.6. Thus, it is found that the RNNPB #5 has the pattern P #2 of the learning data given at the time of learning.

In addition, the RNNPB #5 outputs time-series data that are similar to the pattern P #1 learned by the RNNPB #1 to the RNNPB #3 and the pattern P #3 learned by the RNNPB #7 to the RNNPB #9 when the PB #1 is smaller than 0.6. Thus, it is found that the RNNPB #5 receives the influence of the pattern P #1 acquired by the RNNPB #1 to the RNNPB #3 or the influence of the pattern P #3 acquired by the RNNPB #7 to the RNNPB #9, and also has an intermediate pattern that appears when the pattern P #2 of learning data given to the RNNPB #5 at the time of learning deforms toward the pattern P #1 acquired by the RNNPB #1 to the RNNPB #3 or the pattern P #3 acquired by the RNNPB #7 to the RNNPB #9.

Furthermore, the RNNPB #5 outputs time-series data of a pattern that is not learned by any of the nine RNNPB #1 to RNNPB #9 when the PB ∩1 is larger than 0.6. Thus, it is found that the RNNPB #5 receives the influence of the pattern P #1 acquired by the RNNPB #1 to the RNNPB #3 or the pattern P #3 acquired by the RNNPB #7 to the RNNPB #9, and also has a pattern that appears when the pattern P #2 of learning data given to the RNNPB #5 at the time of learning deforms toward a side opposite to the pattern P #1 acquired by the RNNPB #1 to the RNNPB #3 or a side opposite to the pattern P #3 acquired by the RNNPB #7 to the RNNPB #9.

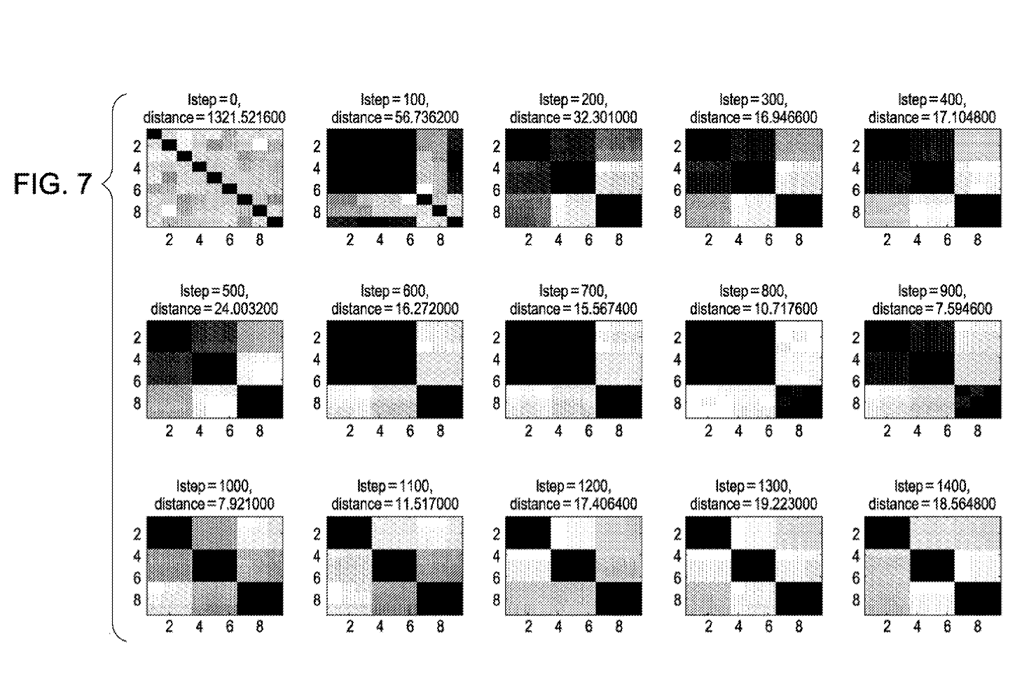

Next, FIG. 7 shows rectangular maps that indicate distances in correlation among the weight matrices of the respective nine RNNPB #1 to RNNPB #9, that is, for example, distances among vectors that have weights constituting each of the weight matrices in a vector space.

Note that as the distance between the weight matrices reduces, the correlation between those two weight matrices becomes higher.

In the maps of FIG. 7, the abscissa axis and the ordinate axis both represent the weight matrices of the respective nine RNNPB #1 to RNNPB #9. A distance between the weight matrix in the abscissa axis and the weight matrix in the ordinate axis is indicated by light and dark. A darker (black) portion indicates that the distance is smaller (a lighter (white) portion indicates that the distance is larger).

In FIG. 7, among the horizontal five by vertical three maps, the upper left map indicates distances among weight matrices when the number of learning times is 0, that is, distances among initialized weight matrices, and, in the map, only distances between the weight matrices of the same RNNPB #1, arranged in a diagonal line, are small.

Hereinafter, FIG. 7 shows maps when learning progresses as it goes rightward and downward, and the lower right map indicates distances among weight matrices when the number of learning times is 1400.

According to FIG. 7, it is found that, as learning progresses, distances among the weight matrices of the RNNPB #1 to RNNPB #3 that have learned time-series data of the same pattern P #1, distances among the weight matrices of the RNNPB #4 to RNNPB #6 that have learned time-series data of the same pattern P #2 and distances among the weight matrices of the RNNPB #7 to RNNPB #9 that have learned time-series data of the same pattern P #3 become small.

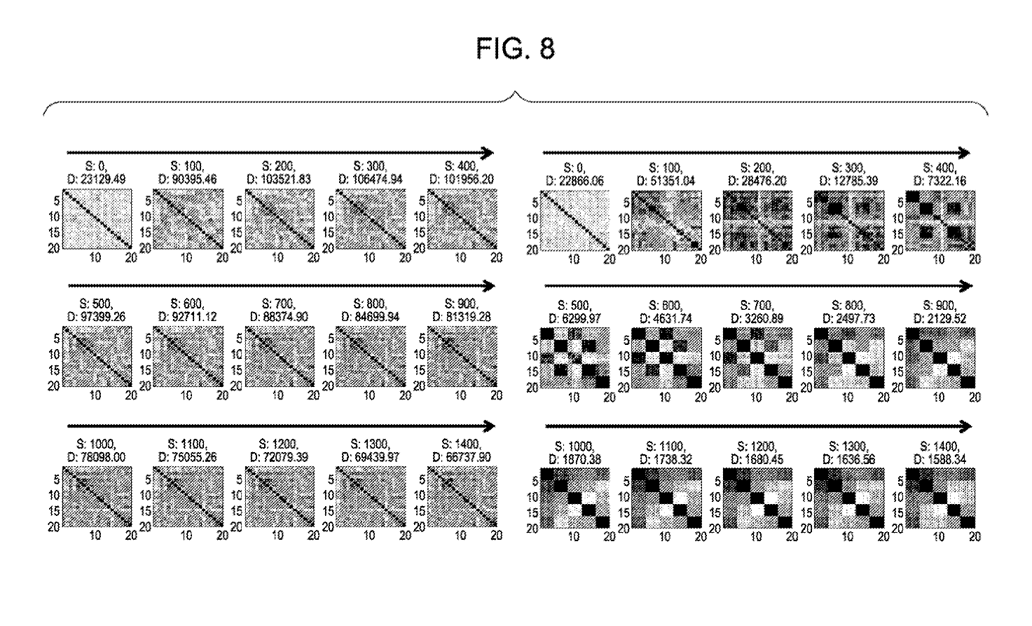

FIG. 8 shows maps similar to those of FIG. 7, indicating that distances as correlation among weight matrices of RNNPBs that have learned time-series data different from those in the case of FIG. 5 to FIG. 7.

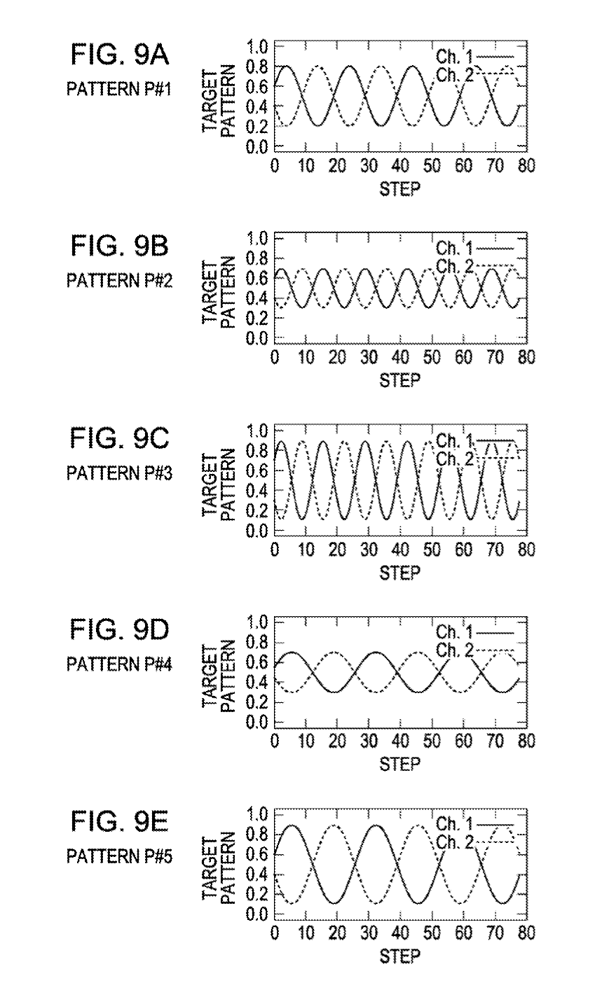

Note that in the simulation for creating the maps of FIG. 8, twenty pieces of time-series data that are obtained by superimposing four different noises N #1, N #2, N #3 and N #4 on each of the pieces of time-series data of five types of patterns P #1, P #2, P #3, P #4 and P #5 shown in FIG. 9 were prepared, and one RNNPB was caused to learn the pieces of time-series data. Thus, the RNNPB used in simulation for creating the maps of FIG. 8 are 20 RNNPB #1 to RNNPB #20.

In addition, when learning, the time-series data of the pattern P #1 were given to the RNNPB #1 to the RNNPB #4, the time-series data of the pattern P #2 were given to the RNNPB #5 to the RNNPB #8, the time-series data of the pattern P #3 were given to the RNNPB #9 to the RNNPB #12, the time-series data of the pattern P #4 were given to the RNNPB #13 to the RNNPB #16, the time-series data of the pattern P #5 were given to the RNNPB #17 to the RNNPB #20.

5×3 maps at the left side in FIG. 8 show maps when sharing is weak, that is, a degree to which all 20 weight matrices w₁ to w₂₀ influence each of the weight matrices w₁ to w₂₀ of the 20 RNNPB #1 to RNNPB #20 is small, specifically, when the coefficient αᵢ of equation (2) is small (when αᵢ is substantially 0).

In addition, 5×3 maps at the right side in FIG. 8 show maps when sharing is strong, that is, when a degree to which all 20 weight matrices w₁ to w₂₀ influence each of the weight matrices w₁ to w₂₀ of the 20 RNNPB #1 to RNNPB #20 is large, specifically, when the coefficient αᵢ of equation (1) is not small.

Both when sharing is weak and when sharing is strong, only distances between the weight matrices of the same RNNPB #i, arranged in a diagonal line, are small in the upper left map when the number of learning times is zero.

Then, it is found that, when sharing is weak, as shown at the left side in FIG. 8, even when learning progresses, no particular tendency appears in the distances among the weight matrices, whereas, when sharing is strong, as shown at the right side in FIG. 8, distances among the weight matrices are small among RNNPBs that have learned, the time-series data of the same patterns.

Thus, it is found that, through the sharing process, distributed representation is formed over a plurality of learning modules, and a plurality of RNNPBs have generalization capability.

Note that a method for update learning of model parameters by the model learning unit 12₁ and a method for sharing process by the model parameter sharing unit 20 are not limited to the above described methods.

In addition, in the present embodiment, in the sharing process by the model parameter sharing unit 20, all the N learning modules 10₁ to 10_{N} share the weight matrices as the model parameters; instead, for example, only a portion of the N learning modules 10₁ to 10_{N} may share the weight matrices as the model parameters.

Furthermore, in the present embodiment, in the sharing process by the model parameter sharing unit 20, the learning modules 10ᵢ share all the plurality of weights, as the plurality of model parameters, that constitute each weight matrix; instead, in the sharing process, no all the plurality of weights that constitute each weight matrix but only a portion of the weights among the plurality of weights that constitute each weight matrix may be shared.

In addition, only a portion of the N learning modules 10₁ to 10_{N} may share only a portion of weights among a plurality of weights that constitute each weight matrix.

Note that, in the learning device shown in FIG. 1, the model parameter sharing unit 20 causes the plurality of learning modules 10₁ to 10_{N} to share the model parameters. That is, in terms of influencing the weight matrices w₁ to w_{N} of the RNNPB #1 to RNNPB #N in the respective learning modules 10₁ to 10_{N} on the weight matrix wᵢ, which has model parameters of the RNNPB #i as a pattern learning model in each learning module 10₁, the learning device shown in FIG. 1 is similar to the technique described in Japanese Unexamined Patent Application Publication No. 2002-024795, in which, at the time of learning of RNNs, contexts of two RNNs are changed on the basis of an error between the contexts of two RNNs, that is, the contexts of two RNNs influence the context of each RNN.

However, in the learning device shown in FIG. 1, the weight matrix, which has model parameters, is influenced, which differs from the technique described in Japanese Unexamined Patent Application Publication No. 2002-024795 in which not model parameters but contexts, which are internal states, are influenced.

That is, when a pattern learning model expressed by a function is taken for example, the model parameters of the pattern learning model are constants (when an input u, an output y, an infernal state x, and equations of states that model systems respectively expressed by y=Cx+Du and x′=Ax+Bu (x′denotes the derivative of x) are taken for example, A, B, C and D correspond to constants) that are obtained through learning and that define the function expressing the pattern learning model, and the constants differ from internal states (internal states x in the example of equations of states) that are not originally constant.

Similarly, in terms of that the weight matrices w₁ to w_{N} of the RNNPB #1 to RNNPB #N in the respective learning modules 10₁ to 10_{N} influence the weight matrix wᵢ, which has model parameters of the RNNPB #i as a pattern learning model in each learning module 10ᵢ, the learning device shown in FIG. 1 is similar to the technique described in Yuuya Sugita, Jun Tani, “Learning Semantic Combinatoriality from the Interaction between Linguistic and Behavioral Processes”, Adaptive Behavior, Vol. 13, No. 1, 33-52 (2005), which changes each of respective PBs of two RNNPBs, that is, respective PBs of the two RNNPBs influence each of the respective PBs of the RNNPBs, on the basis of a difference between the respective PBs of the two RNNPBs at the time of learning of RNNPBs.

However, the learning device shown in FIG. 1 in which the weight matrix, which has model parameters, is influenced differs from the technique described in Yuuya Sugita, Jun Tani, “Learning Semantic Combinatoriality from the Interaction between Linguistic and Behavioral Processes”, Adaptive Behavior, Vol. 13, No. 1, 33-52 (2005), in which not the model parameters but PBs, which are internal states (or correspond to internal states) are influenced.

That is, as described above, the model parameters of the pattern learning model are constants that are obtained through learning and that define the function expressing the pattern learning model, and differ from the internal states, which are not constants.

Then, the model parameters are constants that are obtained through learning and that define the function expressing the pattern learning model. Therefore, at the time of learning, the model parameters are updated (changed) so as to become values corresponding to a pattern to be learned; however, the model parameters are not changed when output data are generated (when input data are input to the input layer of an RNNPB, which is a pattern learning model, and output data corresponding to the input data are output from the output layer of the RNNPB).

On the other hand, the contexts on which technique described in Japanese Unexamined Patent Application Publication No. 2002-024795 focus and the PBs on which the technique described in Yuuya Sugita, Jun Tani, “Learning Semantic Combinatoriality from the Interaction between Linguistic and Behavioral Processes”, Adaptive Behavior, Vol. 13, No. 1, 33-52 (2005) focus are internal states, which differ from the model parameters, so they are changed, of course, both at the time of learning and when output data are generated.

As described above, the learning device shown in FIG. 1 differs from any of the technique described in Japanese Unexamined Patent Application Publication No. 2002-024795 and the technique described in Yuuya Sugita, Jun Tani, “Learning Semantic Combinatoriality from the Interaction between Linguistic and Behavioral Processes”, Adaptive Behavior, Vol. 13, No. 1, 33-53 (2005). As a result, it is possible to obtain a pattern learning model having scalability and generalization capability at a time.

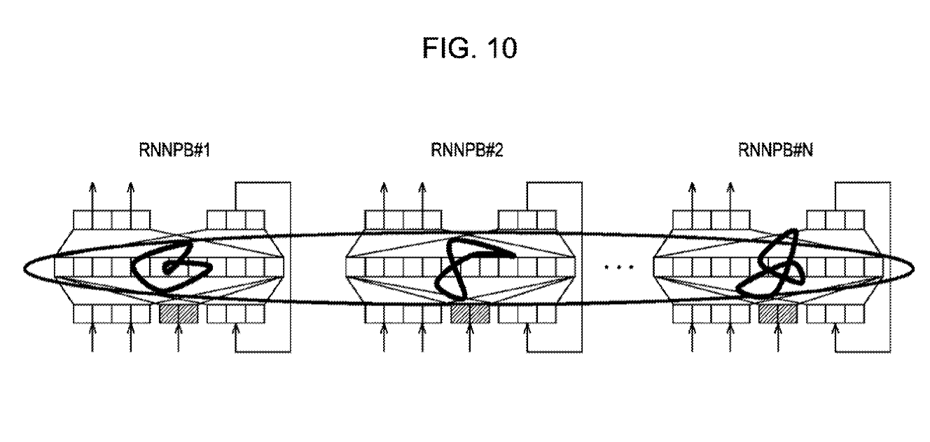

That is, in the learning device shown in FIG. 1, for example, as shown in FIG. 10, respective model parameters of the pattern learning models, such as RNNPBs, are shared.

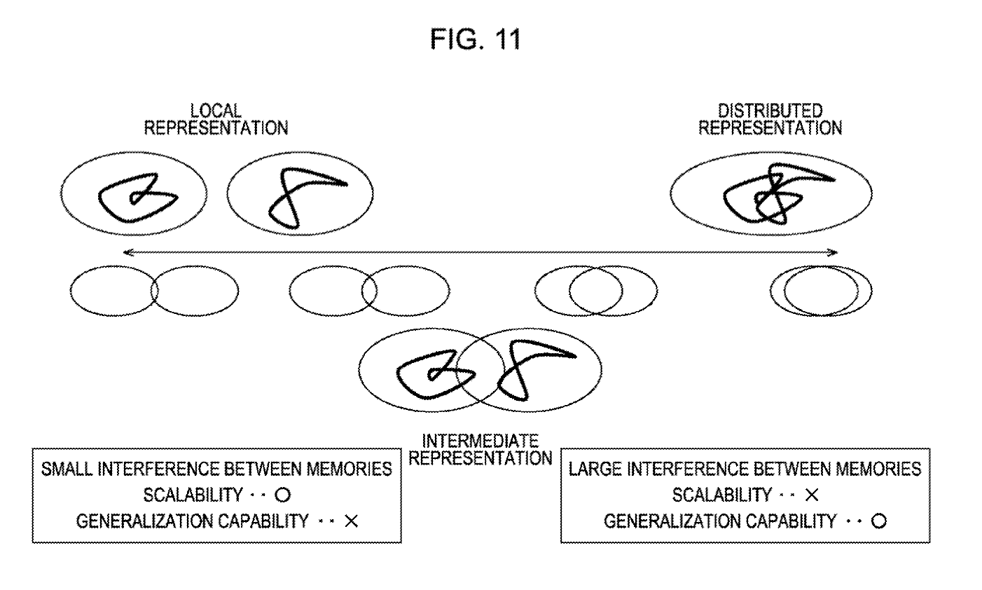

As a result, according to the learning device shown in FIG. 1, as shown in FIG. 11, so to speak, learning of an “intermediate representation” scheme, which has the advantages of both the “local representation” scheme that is excellent in scalability but lacks in generalization capability and the “distributed representation” scheme that has generalization capability but lacks in scalability, is performed. Thus, it is possible to obtain a pattern learning model having both scalability and generalization capability at a time.

Incidentally, when the learning device is formed of the N learning modules 10₁ to 10_{N}, there is a problem that it is difficult to determine whether it may be necessary to add a new learning module.

That is, when new learning data (learning sample) are supplied, the supplied learning data are similar to a time-series pattern that has been learned by the existing pattern learning models. Thus, it is difficult to determine whether it is enough for any one of the existing N learning modules 10₁ to 10_{N} to perform update learning or a new learning module is added for learning because the new learning data are not similar to any of the time-series patterns that have been learned by the N learning modules 10₁ to 10_{N}.

The module learning that is excellent in scalability and, where necessary, adds a learning module for learning, for example, employs a method in which a novelty of a new learning module with respect to the existing learning modules is expressed by numeric value and, when the novelty of the new learning module expressed by the numeric value exceeds a predetermined threshold, adds the new learning module.

However, in the above described method, it is difficult to set a reference for determining whether to add a learning module. If setting is wrong, there is a problem that learning data that should be intrinsically learned by separate learning modules are learned by a single learning module or, on the contrary, learning data that should be learned by a single learning module are learned by separate learning modules.

Then, hereinafter, by utilizing the characteristic that similar model parameters reduce the distance therebetween through the above described sharing process for model parameters, an embodiment in which it is not necessary to determine whether to add a learning module, it is possible to perform learning by adding a learning module (additional learning) and it is also possible to suppress an increase in the number of unnecessary learning modules will be described.

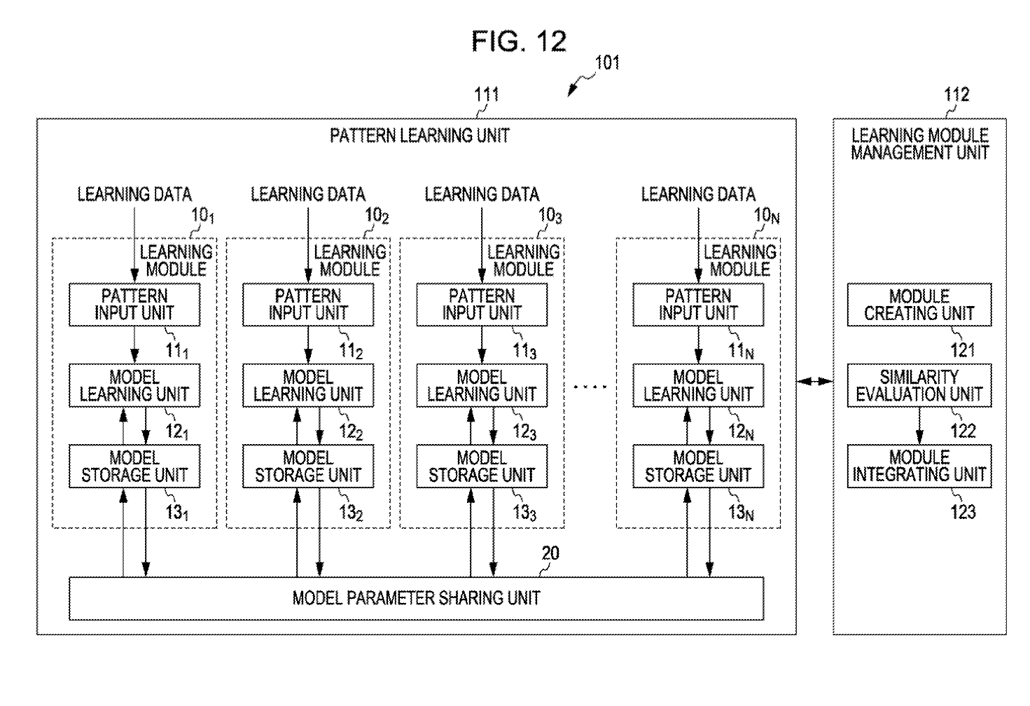

FIG. 12 is a block diagram that shows a configuration example of one embodiment of a learning device to which an embodiment of the invention is applied.

In FIG. 12, like reference numerals denote components corresponding to those of the learning device shown in FIG. 1, and the description thereof is omitted.

That is, the learning device 101 shown in FIG. 12 is formed of a pattern learning unit 111 that has a configuration similar to the learning device shown in FIG. 1 and a learning module management unit 112 that manages learning modules.

The pattern learning unit 111 performs update learning to learn (update) a plurality of model parameters (learning resources) of each pattern learning model using the N learning modules 10₁ to 10_{N}, the number of which is controlled by the learning module management unit 112.

The learning module management unit 112 is formed of a module creating unit 121, a similarity evaluation unit 122 and a module integrating unit 123, and controls the number (N) of learning modules 10₁ to 10_{N} of the pattern learning unit 111.

The module creating unit 121, when new learning data are supplied to the pattern learning unit 111 of the learning device 101, unconditionally creates (adds) a new learning module corresponding to the new learning data in the pattern learning unit 111.

The similarity evaluation unit 122 evaluates similarities among the learning modules of the pattern learning unit 111. Evaluation of similarities among the learning modules may, for example, use a Euclidean distance between the model parameters of the learning modules (hereinafter, referred to as a parameter distance).

Specifically, a parameter distance Dₚₐᵣₐₘₑₜₑᵣ(1,2) between the learning module 10₁ and the learning module 10₂ may be calculated using equation (4). Note that k in equation (4) is a variable for identifying the model parameters of the learning modules 10₁ and 10₂, and, for example, p_{1,k} indicates a kth (k≦Q) model parameter of the learning module 10₁.

$${D}_{parameter} ( 1 , 2 ) = \sqrt{{\sum }_{k = 1}^{Q} {( {p}_{1 , k} - {p}_{2 , k} )}^{2}} \qquad ( 4 )$$

If a pattern learning model has a low redundancy such that model parameters of a pattern learning model for a time-series pattern are uniquely determined, it is possible to easily imagine that a parameter distance is used to evaluate the similarities of pattern learning models. However, for example, in a highly redundant pattern learning model, such as a neural net (RNN), it has a characteristic such that parameter distances reduce among learning modules that learn similar time-series patterns owing to the above described sharing learning process to allow a parameter distance to be used for evaluation of similarities of pattern learning models.

The module integrating unit 123 determines whether to integrate learning modules on the basis of similarities among the learning modules obtained by the similarity evaluation unit 122. Then, when it is determined that there are learning modules that can be integrated, the module integrating unit 123 integrates those learning modules.

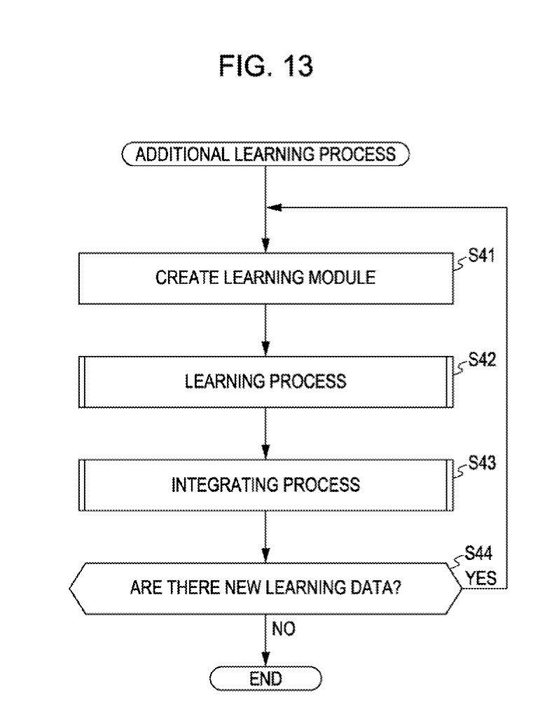

Next, the additional learning process, which is the learning accompanied by addition of a learning module, by the learning device 101 shown in FIG. 12 will be described with reference to the flowchart of FIG. 13.

As new learning data are supplied to the pattern learning unit 111, in step S41, the module creating unit 121 creates a new learning module for the new learning data in the pattern learning unit 111. Hereinafter, the number of learning modules after the new learning module is added is N.

In step S42, the pattern learning unit 111 performs learning process over the learning modules including the new learning module added in the process in step S41. The learning process is similar to the learning process described with reference to FIG. 2, so the description thereof is omitted.

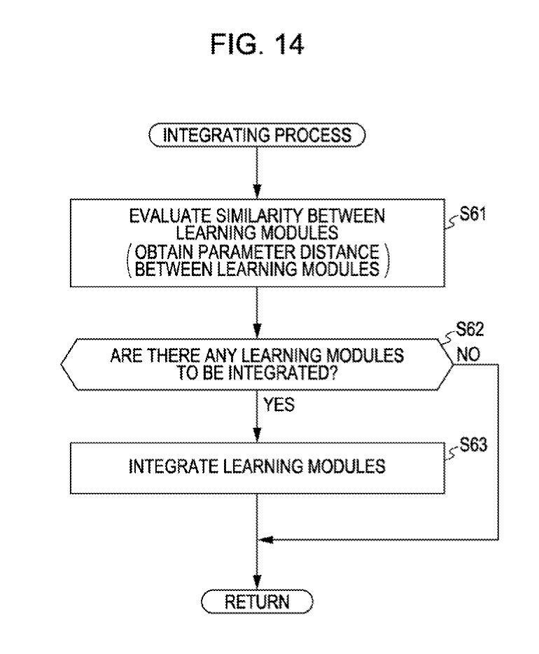

In step S43, the learning module management unit 112 performs integrating process to integrate learning modules on the basis of similarities among the learning modules. The detail of the integrating process will be described later with reference to FIG. 14.

In step 344, it is determined whether there are new learning data, that is, there are any learning data that are not subjected to learning process from among the learning data supplied to the pattern learning unit 111. When it is determined that there are new learning data, the process returns to step S41, and repeats the processes in steps S41 to S44. On the other hand, when it is determined that there are no new learning data, the additional learning process ends.

Next, the detail of the integrating process in step S43 of FIG. 13 will be described with reference to the flowchart of FIG. 14.

In the integrating process, first, in step S61, the similarity evaluation unit 122 evaluates similarities among the learning modules. That is, the similarity evaluation unit 122 obtains parameters distances among the learning modules for all combinations of the N learning modules 10₁ to 10_{N}.

In step S62, the module integrating unit 123 determines whether there are learning modules to be integrated on the basis of the similarities among the learning modules (parameter distances among the learning modules) obtains by the similarity evaluation unit 122. Specifically, the module integrating unit 123, when a parameter distance obtained in step S61 is smaller than a predetermined threshold D_{threshold}, recognizes that the two learning modules having that parameter distance are learning modules to be integrated and then determines that there are learning modules to be integrated.

In step 862, when it is determined that there are learning modules to be integrated, the process proceeds to step S63, and the module integrating unit 123 integrates the learning modules that are determined to be integrated. Specifically, the module integrating unit 123 calculates average values of model parameters of the integrating two learning modules, and sets the calculated average values for the model parameters of the learning module that will survive after integration, and then discards the other learning module from the pattern learning unit 111.

Note that, because it is not appropriate to integrate learning modules that have not sufficiently learned, it may be necessary to integrate learning modules after it is checked that the learning modules determined to be integrated each have sufficiently learned. To determine whether integrating two learning modules have sufficiently learned, it is only necessary to check that learning scores of the two learning modules determined to be integrated are larger than or equal to a predetermined threshold indicating a sufficiently learned state or to determine a similarity between the learning modules after it is checked that learning scores of the learning modules are larger than or equal to a predetermined threshold.

On the other hand, in step S62, when it is determined that there are not learning modules to be integrated, the process in step 363 is skipped, and the integrating process ends (returns to the additional learning process of FIG. 13).

Next, the case where RNNs are employed as pattern learning models will be described. RNNs differ from RNNPBs in that the input layer has no PB units, and update learning, and the like, other than that, may be performed as well as RNNPBs.

When RNNs are employed as pattern learning models, the block diagram that shows the configuration example of the learning device 101 shown in FIG. 12 is such that the pattern learning unit 111 shown in FIG. 12 is configured as shown in FIG. 3. However, each RNNPB #i in FIG. 3 is replaced with an RNN #1 with no PB unit.

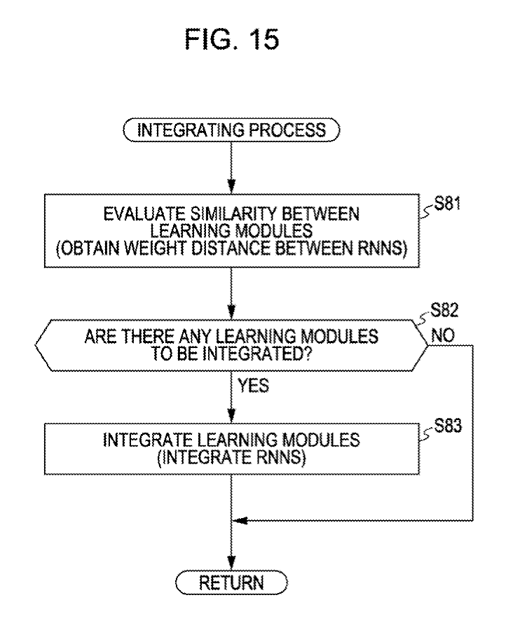

In addition, the flowchart of the additional learning process when RNNs are employed as pattern learning models is such that, because the learning modules created in step S41 of FIG. 13 are RNNs, the learning process in step S42 will be the learning process of FIG. 4 in which the RNNPB #i is replaced with the RNN #i, and the integrating process in step S43 will be the process shown in FIG. 15.

Then, the integrating process in step S43 of FIG. 13 when RNNs are employed as pattern learning models will be described with referent to the flowchart of FIG. 15.

In step S31, the similarity evaluation unit 122 evaluates similarities among the learning modules. In the RNN, a weight corresponds to a model parameter, so the similarity evaluation unit 122 employs a Euclidean distance between weight matrices (hereinafter, referred to as weight distance) to evaluate a similarity between RNNs.

For example, when weights of the weight matrix w₁ of the RNN #1 are respectively w_{1,k,l} (1≦k≦Q, 1≦l≦R), and weights of the weight matrix w₂ of the RNN #2 are respectively w_{2,k,l}, a weight distance D_{weight}(1,2) between the RNN #1 and the RNN #2 may be expressed by equation (5).

$${D}_{weight} ( 1 , 2 ) = \sqrt{{\sum }_{k = 1}^{Q} {\sum }_{l = 1}^{R} {( {w}_{1 , k , l} - {w}_{2 , k , l} )}^{2}} \qquad ( 5 )$$

The similarity evaluation unit 122 obtains weight distances among the RNNs over all combinations of the N learning modules 10₁ to 10_{N} (RNN #1 to RNN #N).

In step S82, the module integrating unit 123 determines whether there are any learning modules to be integrated on the basis of similarities among the RNNs, obtained by the similarity evaluation unit 122. That is, the module integrating unit 123, when a weight distance obtained in step S81 is smaller than a predetermined threshold D_{threshold}, recognizes that the two learning modules having that weight distance are learning modules to be integrated and then determines that there are learning modules to be integrated.

In step S32, when it is determined that there are learning modules to be integrated, the process proceeds to step S83, and the module integrating unit 123 integrates the learning modules (RNNs) that are determined to be integrated. Specifically, the module integrating unit 123 calculates an average value of weight matrices of the integrating two RNNs, and sets the calculated average value for the weight matrix of the RNN that will survive after integration, and then discards the other RNN from the pattern learning unit 111.

When the pattern learning models are RNNs as well, it may be necessary to check that integrating two RNNs have sufficiently learned. In the RNNs, for example, by determining whether a learning error is smaller than a predetermined threshold, it is checked that RNNs have sufficiently learned, and then integrating two RNNs are integrated.

On the other hand, in step S82, when it is determined that there are not learning modules to be integrated, the process in step S83 is skipped, and the integrating process ends (returns to the additional learning process of FIG. 13).

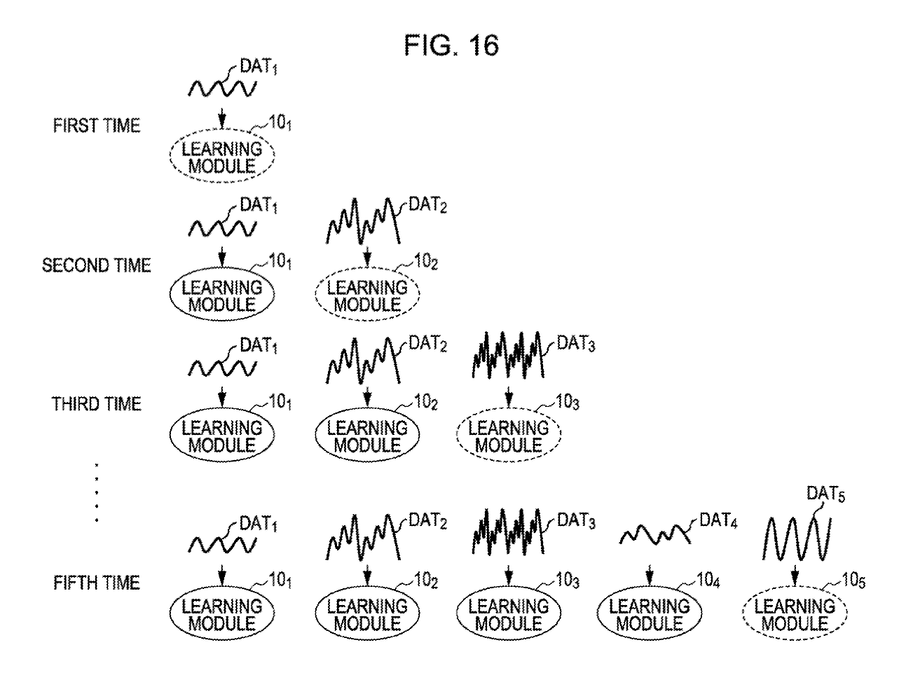

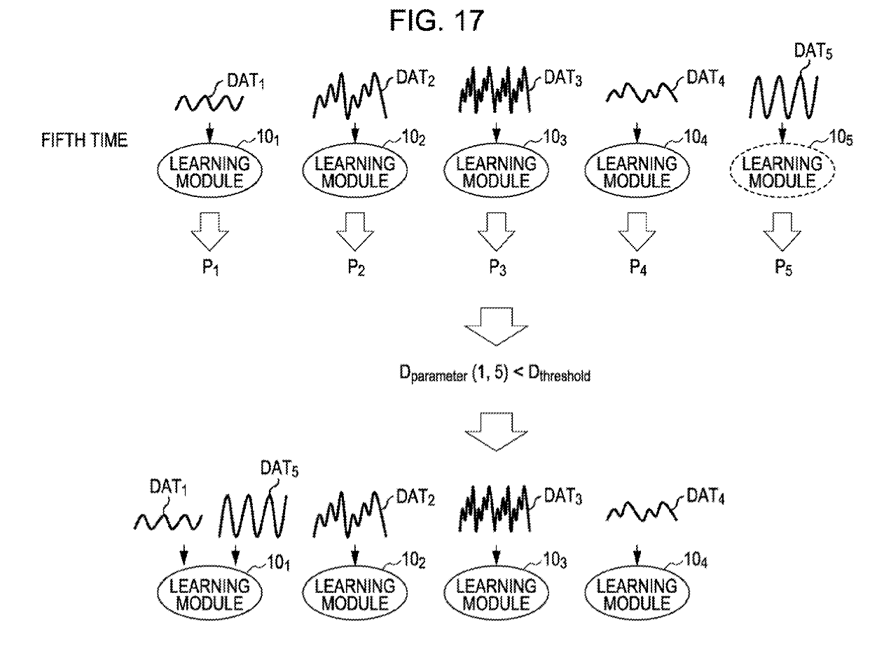

FIG. 16 and FIG. 17 are views that conceptually show the additional learning process performed by the learning device 101.

FIG. 16 is a view that conceptually shows a process in which one piece of new learning data is supplied for one additional learning process, and the module creating unit 121 adds one new learning module each time the additional learning process of FIG. 13 is performed.

As new learning data DAT₁ are supplied to the pattern learning unit 111, a first additional learning process is executed, and the learning module creating unit 121 creates a new learning module 10₁ for the learning data DAT₃.

Next, as new learning data DAT₂ are supplied to the pattern learning unit 111, a second additional learning process is executed, and the learning module creating unit 121 creates a new learning module 10₂ for the learning data DAT₂. Furthermore, as new learning data DAT₃ are supplied to the pattern learning unit 111, a third additional learning process is executed, and the learning module creating unit 121 creates a new learning module 10₃ a for the learning data DAT₃. In the following, similarly, as new learning data DAT₅ are supplied to the pattern learning unit 111, a fifth additional learning process is executed, and the learning module creating unit 121 creates a new learning module 10₅ for the learning data DAT₅.

In each of the first to fifth additional learning processes, as described with reference to FIG. 13, the learning process (process in step S42) is performed over the learning modules including the added learning module(s), and subsequently, the integrating process (process in step S43) is performed.

Then, it is assumed that it is determined in each of the first to fourth additional learning processes that there are no learning modules to be integrated, and then it is determined in the fifth additional learning process that it is possible to integrate the learning module 10₁ with the learning module 10₅.

FIG. 17 is a view that conceptually shows a process when the learning module 10₁ is integrated with the learning module 10₅.

It is assumed that, in the fifth additional learning process, when, after the learning process is completed, the module integrating unit 123 determines whether there are any learning modules to be integrated on the basis of similarities among the learning modules obtained by the similarity evaluation unit 122, and then the determination result indicates that it is possible to integrate the learning module 10₁ with the learning module 10₅. That is, the result indicates that a parameter distance Dₚₐᵣₐₘₑₜₑᵣ(1, 5) between the learning module 10₁ and the learning module 10₅ is smaller than the threshold D_{threshold}.

In this case, the module integrating unit 123 calculates average values of model parameters P₁ of the learning module 10₁ and model parameters P₅ of the learning module 10₅, and sets the average values for the model parameters P₁ of the integrated learning module 10₁, and then discards the learning module 10₅ from the pattern learning unit 111.

Note that FIG. 17 shows an example in which two learning module 10₁ and learning module 10₅ are integrated into one learning module 10₁; however, the number of integrating learning modules is not limited to two. For example, when it is determined that three learning modules have parameter distances smaller than the threshold D_{threshold} with respect to one another, the three learning modules may be integrated into one learning module. In this case, model parameters of the integrated learning module may used average values of the model parameters of the integrating three learning modules.

The model parameter Pᵢ of the learning module 10ᵢ shown in FIG. 17 represents all p_{i,1} to p_{i,4} in equation (4). The average values between the model parameters P₁ and the model parameters P₅ mean that the average value between p_{1,1} and p_{5,1}, the average value between p_{1,2} and p_{5,2}, the average value between p_{1,3} and p_{5,3}, the average value between p_{1,4} and p_{5,4}, . . . , and the average value between p_{1,Q} and p_{5,Q} are respectively set as p_{1,1}, p_{1,2}, p_{1,3}, p_{1,4}, . . . , and p_{1,Q} after integration. Note that calculation results other than average values may be set for model parameters of a learning module that survives after integration. That is, it is possible to obtain model parameters of a learning module that survives after integration by calculation other than average values of model parameters of a plurality of integrating learning modules.

As described above, according to the learning device 101 shown in FIG. 12, it is possible to obtain a pattern learning model having both scalability and generalization capability at a time, and, when new learning data (learning sample) are supplied, the module creating unit 121 unconditionally creates (adds) a new learning module for the new learning data, so it is not necessary to determined whether to add a learning module. In addition, after learning (update learning) process, learning modules having high similarity are integrated, so it is possible to suppress an unnecessary increase in the number of learning modules.

Note that when a learning module is created in response to new learning data supplied to the learning device 101, initial values of model parameters of the creating learning module may be values determined through random number, or the like, or may be average values of model parameters of existing all learning modules. When average values of model parameters of existing all learning modules are assigned as initial values of model parameters of an additional learning module, for example, in comparison with initial values are assigned irrespective of the model parameters of the existing learning modules as in the case where the initial values are assigned by random number, or the like, the additional learning module already has commonality of a pattern held by the existing learning modules. Thus, it is possible to perform learning quickly.

The above described series of processes may be implemented by hardware or may be implemented by software. When the series of processes are executed by software, a program that constitutes the software is installed onto a general-purpose computer, or the like.

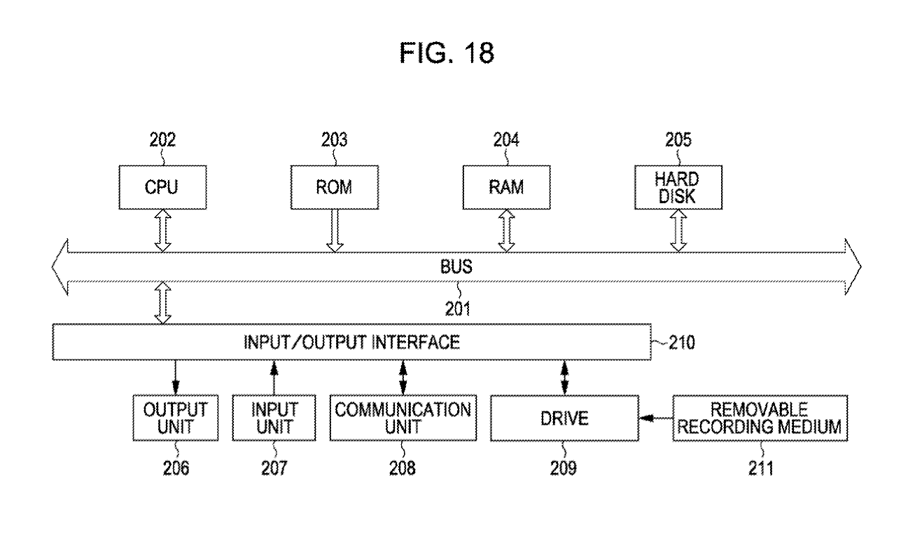

Then, FIG. 18 shows a configuration example of one embodiment of a computer to which a program that executes the above described series of processes are installed.

The program may he recorded in advance in a hard disk 205 or a ROM 203, which serves as a recording medium, provided in the computer.

Alternatively, the program may be temporarily or permanently stored (recorded) in a removable recording medium 211, such as a flexible disk, a CD-ROM (Compact Disc Read Only Memory), a MO (Magneto Optical) disk, a DVD (Digital Versatile Disc), a magnetic disk, and a semiconductor memory. The above removable recording medium 211 may be provided as a so-called packaged software.

Note that the program may be not only installed from the above described removable recording medium 211 onto the computer, but also transferred from a download site through a satellite for digital satellite broadcasting onto the computer by wireless communication or transferred through a network, such as a LAN (Local Area Network) and the Internet, onto the computer by wired communication, and the computer may receive the program transferred in that way by a communication unit 208 to install the program onto the internal hard disk 208.

The computer includes a CPU (Central Processing Unit) 202. An input/output interface 210 is connected to the CPU 202 via a bus 201. As a command is input through an input unit 207, formed of a keyboard, a mouse, a microphone, or the like, operated by the user through the input/output interface 210, the CPU 202 executes the program stored in the POM (Read Only Memory) 203 in accordance with the user's operation. Alternatively, the CPU 202 loads the program stored in the hard disk 205, the program transferred from a satellite or a network, received by the communication unit 208 and then installed onto the hard disk 205, or the program read from the removable recording medium 211 mounted on the drive 209 and then installed onto the hard disk 205, onto the RAM (Random Access Memory) 204 and then executes the program. Thus, the CPU 202 performs the process in accordance with the above described flowchart or performs the process performed by the configuration shown in the above described block diagram. Then, the CPU 202, where necessary, outputs the processing result from an output unit 206 formed of, for example, an LCD (Liquid Crystal Display), a speaker, or the like, through the input/output interface 210, or transmits the processing result from the communication unit 208, and then records the processing result in the hard disk 205.

Here, in the specification, process steps that describe a program for causing the computer to execute various processings are not necessarily processed in time sequence in the order described as the flowchart, but also include processes that are executed in parallel or separately (for example, parallel process or process using an object).

In addition, the program may be processed by a single computer or may undergo distributed processing by a plurality of computers. Furthermore, the program may be transferred to a remote computer and then executed.

In addition, the embodiment of the invention is not limited to the above described embodiment and may be modified into various forms without departing from the scope of the invention.

That is, the embodiment of the invention is not a method specialized to a certain specific space pattern and a time-series sequence and pattern. Thus, the embodiment of the invention may be applied to prediction or classification of a pattern on the basis of learning and learned results of a user input through a user interface of a computer, a pattern of a sensor input and motor output of a robot, a pattern related to music data, a pattern related to image data, and a pattern of a phoneme, a word, a sentence, and the like, in language processing.

The present application contains subject matter related to that disclosed in Japanese Priority Patent Application JP 2008-178806 filed in the Japan Patent Office on Jul. 9, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A learning device comprising:
a plurality of learning modules, each of which performs update learning to update a plurality of model parameters of a pattern learning model that learns a pattern using input data;
model parameter sharing means for causing two or more learning modules from among the plurality of learning modules to share the model parameters;
module creating means for creating a new learning module corresponding to new learning data for learning the pattern when the new learning data are supplied as the input data;
similarity evaluation means for evaluating similarities among the learning modules after the update learning is performed over all the learning modules including the new learning module; and
module integrating means for determining whether to integrate the learning modules on the basis of the similarities among the learning modules and integrating the learning modules.

2. The learning device according to claim 1, wherein the module creating means assigns average values of the model parameters of all the existing learning modules as initial values of the plurality of model parameters of the new learning module.

3. The learning device according to claim 1, wherein the module integrating means sets average values of the model parameters of a plurality of the integrating learning modules for model parameters of the learning module after integration.

4. The learning device according to claim 1, wherein the pattern learning model is a model that learns a time-series pattern or dynamics.

5. The learning device according to claim 1, wherein the pattern learning model is an HMM, an RNN, an FNN, an SVR or an RNNPB.

6. The learning device according to claim 1, wherein the model parameter sharing means causes all or a portion of the plurality of learning modules to share the model parameters.

7. The learning device according to claim 1, wherein the model parameter sharing means causes two or more learning modules from among the plurality of learning modules to share all or a portion of the plurality of model parameters.

8. The learning device according to claim 1, wherein the model parameter sharing means corrects the model parameters updated by each of the two or more learning modules using a weight average value of the model parameters updated respectively by the two or more learning modules to thereby cause the two or more learning modules to share the model parameters updated respectively by the two or more learning modules.

9. A learning method comprising the steps of:
performing update learning to update a plurality of model parameters of a pattern learning model that learns a pattern using input data in each of a plurality of learning modules;
causing two or more learning modules from among the plurality of learning modules to share the model parameters;
creating a new learning module corresponding to new learning data for learning the pattern when the new learning data are supplied as the input data;
evaluating similarities among the learning modules after the update learning is performed over all the learning modules including the new learning module; and
determining whether to integrate the learning modules on the basis of the similarities among the learning modules and integrating the learning modules.

10. A program for causing a computer to function as:
a plurality of learning modules, each of which performs update learning to update a plurality of model parameters of a pattern learning model that learns a pattern using input data;
model parameter sharing means for causing two or more learning modules from among the plurality of learning modules to share the model parameters;
module creating means for creating a new learning module corresponding to new learning data for learning the pattern when the new learning data are supplied as the input data;
similarity evaluation means for evaluating similarities among the learning modules after the update learning is performed over all the learning modules including the new learning module; and
module integrating means for determining whether to integrate the learning modules on the basis of the similarities among the learning modules and integrating the learning modules.

11. A learning device comprising:
a plurality of learning modules, each of which performs update learning to update a plurality of model parameters of a pattern learning model that learns a pattern using input data;
a model parameter sharing unit that causes two or more learning modules from among the plurality of learning modules to share the model parameters;
a module creating unit that creates a new learning module corresponding to new learning data for learning the pattern when the new learning data are supplied as the input data;
a similarity evaluation unit that evaluates similarities among the learning modules after the update learning is performed over all the learning modules including the new learning module; and
a module integrating unit that determines whether to integrate the learning modules on the basis of the similarities among the learning modules and integrates the learning modules.
